(19) United States
(12) Patent Application Publication
(10) Pub. No.: US 2014/0250138 A1
(43) Pub. Date: Sep. 4, 2014

(54) METHOD AND APPARATUS FOR OPTIMIZING LOG FILE FILTERING

(71) Applicant: VONAGE NETWORK LLC, Holmdel, NJ (US)

(72) Inventor: AMNON FRILING, EAST WINDSOR, NJ (US)

(73) Assignee: VONAGE NETWORK LLC, Holmdel, NJ (US)

(21) Appl. No.: 13/783,836

(22) Filed: Mar. 4, 2013

(51) Int. Cl. G06F 17/30

(52) U.S. Cl. CPC G06F 17/30699
USPC 707/754

(57) ABSTRACT

A method and apparatus for optimizing list filtering comprising receiving a list of items from one or more servers, matching the list of items against a set of filters, ordering the set of filters based on the frequency of matches for the set of filters for each filter in the set of filters and applying the ordered set of filters for matching on a next received list of items.

### BACKGROUND OF THE INVENTION

1. Field of the Invention

Embodiments of the present invention generally relate to applications which generate predictable and repetitive text lines in their log files such as voice over internet protocol (VoIP) applications, networking and reporting applications or the like, and more specifically, to a method and apparatus for optimizing log file filtering.

2. Description of the Related Art

Element Management Systems (EMS) provide a means to monitor networked elements such as servers, gateway devices, and all elements which generate predictable and repetitive text lines in log files. The purpose of an application's log file(s) is to provide insight into the application's activity, especially when the application records critical events such as failures or any event which requires immediate attention in the log file(s). EMS's usually include an agent which reads each new line of a log file and runs it through multiple filters in order to match the line and identify the line so that the proper information is forwarded to the EMS which then generates an alert related to that line.

When troubleshooting, engineers or administrators often need to perform a search through the log files which store information regarding events related to a server or an application. In order to investigate an event or an error, all log files from various servers are processed against a set of filters, previously defined by the engineers, to target errors or error conditions. However, processing multiple large log files from many servers against a large list of filters to produce matching events becomes inefficient and time-consuming, deteriorating network and server performance, and negatively impacting customer satisfaction.

Therefore, there is a need in the art for a method for optimizing log file filtering

### SUMMARY OF THE INVENTION

The present invention generally relates to a method and apparatus for optimizing list filtering comprising receiving a list of items from one or more servers, matching the list of items against a set of filters, ordering the set of filters based on the frequency of matches for the set of filters for each filter in the set of filters and applying the ordered set of filters for matching on a next received list of items.

The present invention further relates to an apparatus for optimizing list filtering comprising a filtering module for receiving a list of items from one or more server, the filter module further comprising a filter processor for matching the list of items against a set of filters, and a sorting module, coupled to the filter module, for ordering the set of filters based on the frequency of matches for each filter in the set of filters and applying the ordered set of filters for matching on a next received list of items.

Various advantages, aspects and features of the present disclosure, as well as details of an illustrated embodiment thereof, are more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting the ordering apparatus in accordance with exemplary embodiments of the present invention;

FIG. 2 is a block diagram depicting a more detailed view of the ordering apparatus in accordance with exemplary embodiments of the present invention;

FIG. 3 depicts a computer system for implementation the ordering apparatus of FIG. 1 in accordance with at least one embodiment of the present invention; and

FIG. 4 is a flow diagram for a method in accordance with exemplary embodiments of the present invention.

### DETAILED DESCRIPTION

The present invention is directed to a method and apparatus for improving the performance of analyzing and processing of log files generated by various applications and systems. The log files for various servers are received and run through a set of filters. Once a line is identified, i.e. matched, by a particular filter, the processing is halted. The filter that matches the line has an associated count, and the count is incremented each time a line matches that filter.

After processing the entire log file, or the received portion of the log file, each filter is given a count equaling the number of lines that matched that filter in the log file. The list of filters is subsequently sorted based on the count of each filter; for example, the filter which matched the most lines from the log file will appear first in the list of filters, and the filter with the least count will appear last in the list of filters. When the log file is subsequently filtered, the ordered filter list will be applied to the log file and the filters will be tested against the log file in the order from the filter with the greatest count to the filter with the least count. After a predetermined number of iterations of filtering the log file, or based on a timed schedule, the process will restart so that the filter counts will be recalculated and the list of filters will be reordered based on the most recent log file entries. According to some embodiments, more precise filtering can be achieved for servers' whose activities vary with time: hour of the day, day of the week, and the like.

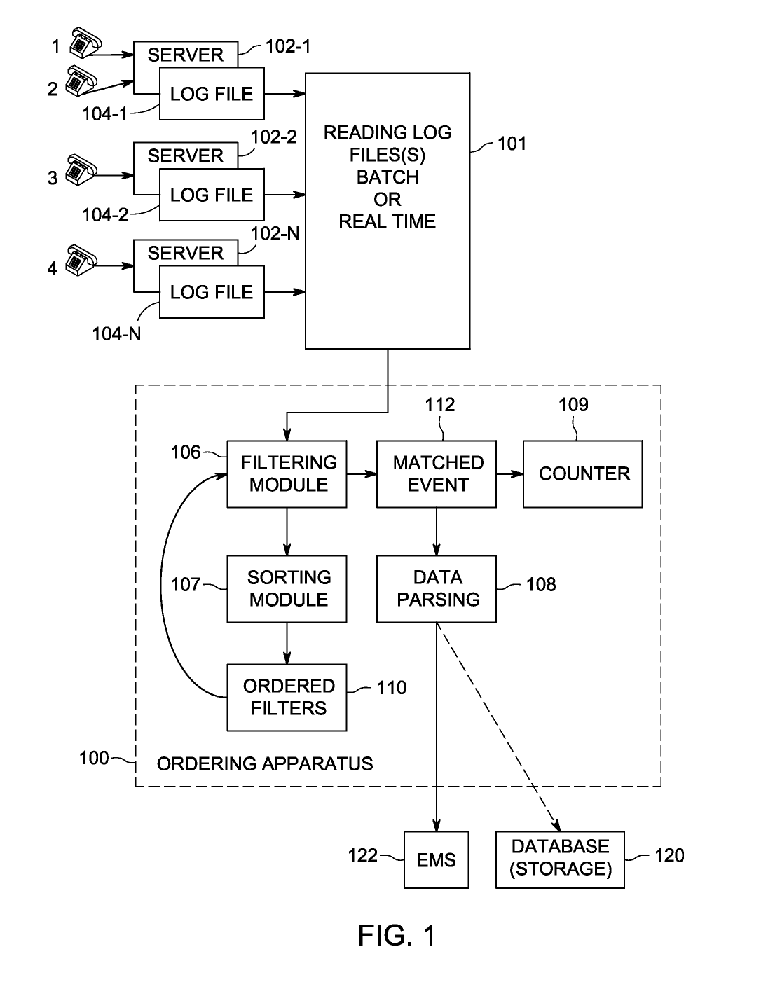

FIG. 1 is a block diagram depicting the ordering apparatus in accordance with exemplary embodiments of the present invention. The ordering apparatus 100 comprises a filter module 106 and a sorting module 107. Various calls take place over network 101, for example, from Device 1 to Device 2, Device 3 to Device 4 . . . from Device N to Device N+1. According to an exemplary embodiment, the network 101 is a VoIP network, but may represent any type of network known to those of ordinary skill in the art. Call 1 to Call N travel through the network 101 to reach the destination device, and as they travel through the network 101, they generate events to be logged. An event line (using VoIP) provides: 1. The called number and calling number along with date/time and which server processed the request. 2. If the call was answered or went to voicemail. 3. The duration of the call. 4. The audio quality. 5. If the server is stressed and is reaching processing capacity, or if the server is running low on disk space. There is no rule what can be included, and often, positive/non-error information is included, such as “connectivity to . . . has been restored”, “received a heartbeat from . . . ” etc. . . . . For example, call 1 logs events to log 104-1 on server 102-1, call 2 also logs events to log 104-1 on server 102-1, call 3 logs events to log 104-2 on server 102-2 . . . call 4 logs events to log 104-N on server 102-N.

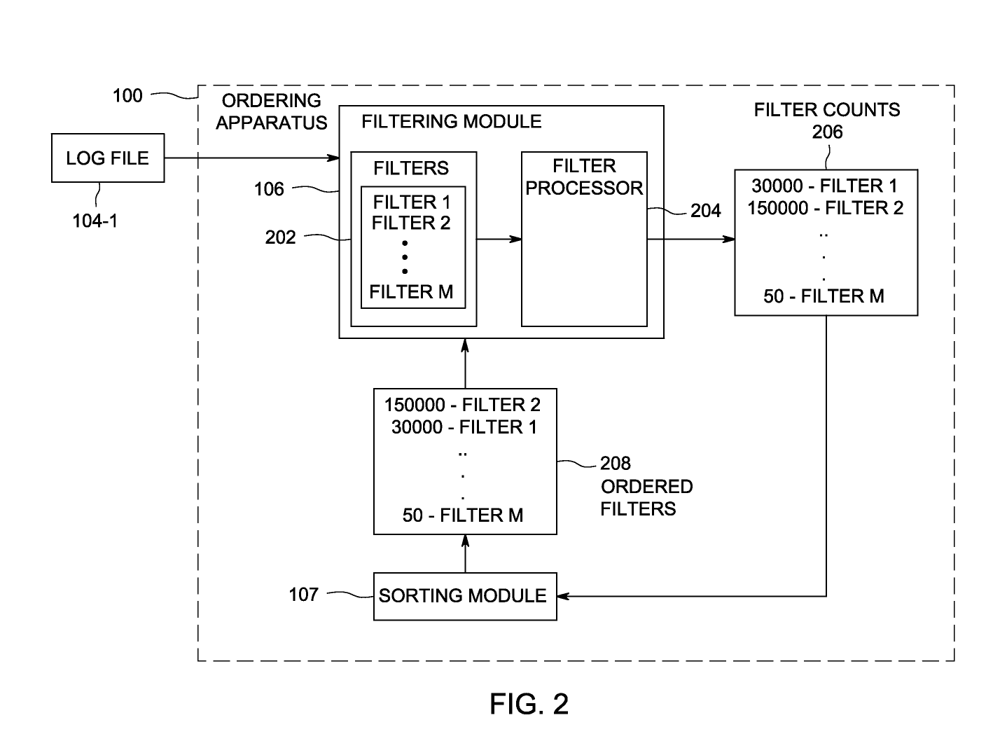

The servers 102-1 to 102-N store the log files in memory (externally or internally). Periodically, the ordering apparatus 100 retrieves the logs 104-1 to 104-N, and processes the logs, either serially or in parallel, to categorize and match the logged events to aid in troubleshooting and resolving technical issues, customer support, compilation of network statistics and archiving. The ordering apparatus 100 comprises a filter module 106 and a sorting module 107, matched events 112 and counter 109. The filter module 106 receives the logs 104-1 to 104-N in and runs the logs through a set of filters. The sorting module 107 sorts the filters according to their matching frequency and outputs the ordered filters 110, described in further detail with respect to FIG. 2. The new ordered filter list is then fed back into filtering module 106 for processing the next group of lines from log files 104-1 to 104-N.

According to some other embodiments of the present invention, the logs 104-1 to 104-N are stored in a database 120 after data parsing 108 or accessed by EMS 122. The ordering apparatus 100 then retrieves the logs as database records from database 120 and performs filtering on the records to produce matched events 112, which may also be stored in the database 120. According to this embodiment, the filters are also stored in the database 120 and may be modified and retrieved by an administrator.

According to other embodiments of the present invention, a portion of the log files 104-1 to 104-N are streamed to the ordering apparatus 100. For example, a “tail-f log1” UNIX function continuously outputs the new lines of a file named “log1”. According to this embodiment, a tail function as described above will be applied to each log-file and the output of the tail function is streamed to the ordering apparatus 100 for filtering and processing to produce matching events 112.

Accordingly, the filters in the filtering module 106 will be re-sorted by the sorting module 107 periodically based on time, log file size, or any administrator preconfigured condition. According to some embodiments, the filtering module 106 will generate new counts for each filter after a preconfigured number of events or items in the log files are received and matched.

FIG. 2 is a block diagram depicting a more detailed view of the ordering apparatus 100 in accordance with exemplary embodiments of the present invention. The log file 104-1, for example, is received at the filtering module 106. The filters 202 comprise, for example, individual filters, 1 . . . M. The filters 202 are also either received at the filtering module 106, or are previously stored in memory in the filtering module 106. According to one embodiment, the filters 1 . . . M may comprise textual strings. A typical filter takes advantage of the power of the REGEX (Regular Expression) engines of programming languages such as Tcl, Perl, Python, Java, and the like. A regular expression is a specific method and pattern for providing a concise and flexible means to “match” (specify and recognize) strings of text, such as particular characters, words, or patterns of characters. The regex command performs two tasks in one: identifies a match and performs parsing of parts of the line as prescribed.

The filter processor 204 processes the log-file 104-1 as a whole, or processes a streaming portion of the log file 104-1 and applies each filter 1 . . . M to the log file or portion of the log file 104-1. For example, each line of the portion of the log file 104-1 is compared to each filter by the filter processor 204, beginning from filter 1 to filter M. Once one of the filters 1 . . . M has matched the current line of the log file 104-1, the filter processor 204 moves to the next line of the log file 104-1 immediately, without testing the current line to determine whether it matches with any of the other filters.

The filter processor 204 considers a match as a “short circuit” for that particular filter, and immediately moves to the next line. In addition, the filter processor 204 stores a count for each filter. Every time a line from a log file matches filter 1 for example, the count for filter 1 is incremented by 1. Similarly, if a line matches filter 2 or filter 3, their respective counts are increased. Once an entire log file or the received portion of the log file is processed by the filter processor 204, the filter processor 204 outputs a set of filter counts 206. According to FIG. 2, filter 1 matched 30,000 lines in log file 104-1, filter 2 matched 150,000 lines and filter M matched 50 lines.

The filter counts 206 are received by the sorting module 107. The sorting module 107 sorts the filters 1 . . . M numerically from greatest count to least count. According to the filter counts 206, filter 2 had a count of 150,000, filter 1 had a count of 30,000 and filter M had a count of 50. Accordingly, filter 2 will be ordered as the first filter, filter 1 will appear after filter 1, and filter M will appear both after filter 2 and filter 1. This set of ordered filters 208 is depicted as being coupled with the filtering module 106 once again.

During the second iteration of executing the filter processor 204 against a new portion of the log file 104-1, the ordered filters 208 are applied to reduce processing time of the log file significantly from the initial run. Specific logs tend to record similar information over time periods, so it is highly likely that the first line of the new portion of the log file 104-1 will match the first filter, and then the filter processor will “short circuit”, i.e., the filter processor will stop matching to incur less processing time trying to match the current line with each filter. If the nature of the log file content has changed over time, subsequent generations of the filter counts 206 and the ordered filters 208 will adapt and adjust the filtering order, hence maintaining processing time to a minimum.

According to other embodiments, the filters 1 . . . M are structured as procedures in a program, stored as Tcl code, for example. In the Tcl language, the frequency of procedures (functions) being executed can be recorded and the procedures ordered according to their frequency of execution. The filter processor 204 may be implemented as a Tcl program which applies the filters (as a set of procedures) to the log file 104-1 and counts each procedure call. The sorting module 107 uses the counts of the procedures to reorder the procedure calls. The filter processor 204 will execute again using the new order of procedures and incur less processing time in producing the categorization of events in the log file 104-1.

In some instances, it is likely that in, for example, log file 104-1, there may be several thousands of lines which indicate that all processes are running well. For troubleshooting purposes, the filters 1 . . . M only represent cases which are errors, so that the filter module 106 can help determine the source and cause of the errors. An event that indicates all processes are running well will not be processed, but because of the significant number of times that this occurs in the log file 104-1, each filter from the filters 202 will be applied to each of those “running well” events, and eventually will not be matched.

This incurs a significant overhead in processing the log file 104-1. To avoid this processing overhead, in the first round of execution of the filter processor 204, the filter processor 204 recognizes that events in the log files for which no filter exists and the events occurs frequently. In these instances, the unimportant events may be added to an “ignore” list and not filtered at all, or removed from the log files completely before applying filtering. Another alternative is for the program to generate additional filters based on the provided “ignore” list. In Tcl, the program will write additional procedures for the lines to be ignored in a separate file, and then “source” that file. This effectively merges the two programs into one.

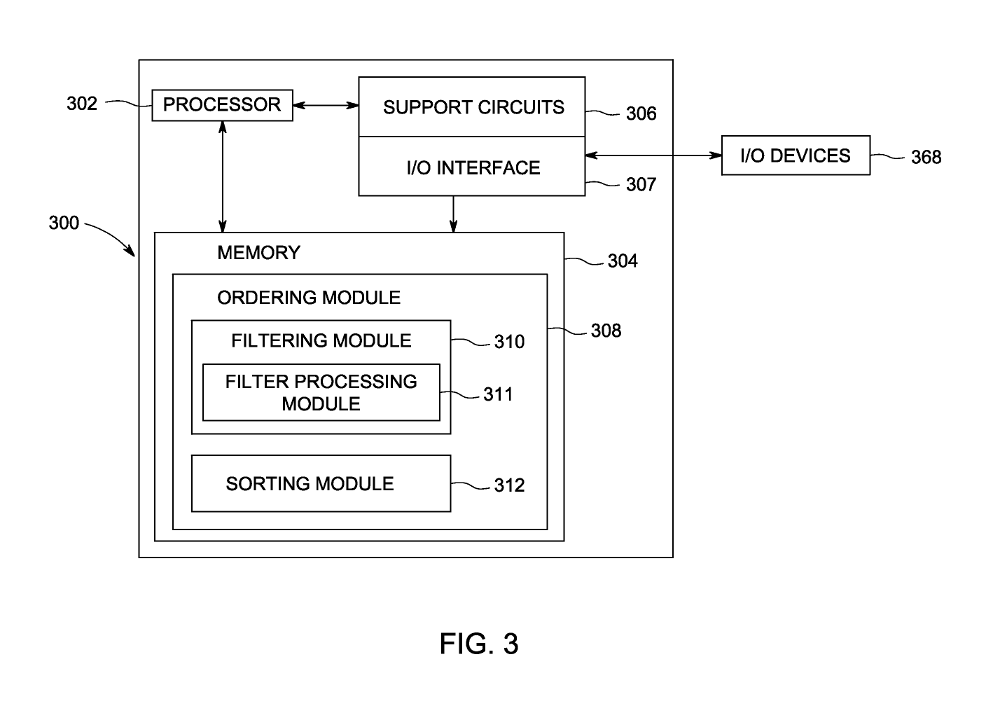

FIG. 3 depicts a computer system 300 for implementation of the ordering apparatus 100 of FIG. 1 in accordance with at least one embodiment of the present invention. In some embodiments, the ordering apparatus 100 may be implemented using a plurality of such computers, for example a group of servers. The computer 300 includes a processor 302, various support circuits 306, and memory 304. The processor 302 may include one or more microprocessors known in the art.

The support circuits 306 for the processor 302 include conventional cache, power supplies, clock circuits, data registers, I/O interface 307, and the like. The I/O interface 307 may be directly coupled to the memory 304 or coupled through the supporting circuits 306. The I/O interface 307 may also be configured for communication with input devices and/or output devices 368 such as network devices, various storage devices, mouse, keyboard, display, video and audio sensors, IMU and the like.

The memory 304, or computer readable medium, stores non-transient processor-executable instructions and/or data that may be executed by and/or used by the processor 302. These processor-executable instructions may comprise firmware, software, and the like, or some combination thereof. Modules having processor-executable instructions that are stored in the memory 304 comprise a ordering module 308.

In an exemplary embodiment, the ordering module 308 comprises a filter module 310 and a sorting module 312. The filter module 310 further comprises a filter processing module 311. The computer 300 may be programmed with one or more operating systems, which may include OS/2, Java Virtual Machine, Linux, SOLARIS, UNIX, HPUX, AIX, WINDOWS, WINDOWS95, WINDOWS98, WINDOWS NT, AND WINDOWS2000, WINDOWS ME, WINDOWS XP, WINDOWS SERVER, WINDOWS 8, IOS, ANDROID among other known platforms.

The memory 304 may include one or more of the following random access memory, read only memory, magneto-resistive read/write memory, optical read/write memory, cache memory, magnetic read/write memory, and the like, as well as signal-bearing media as described below.

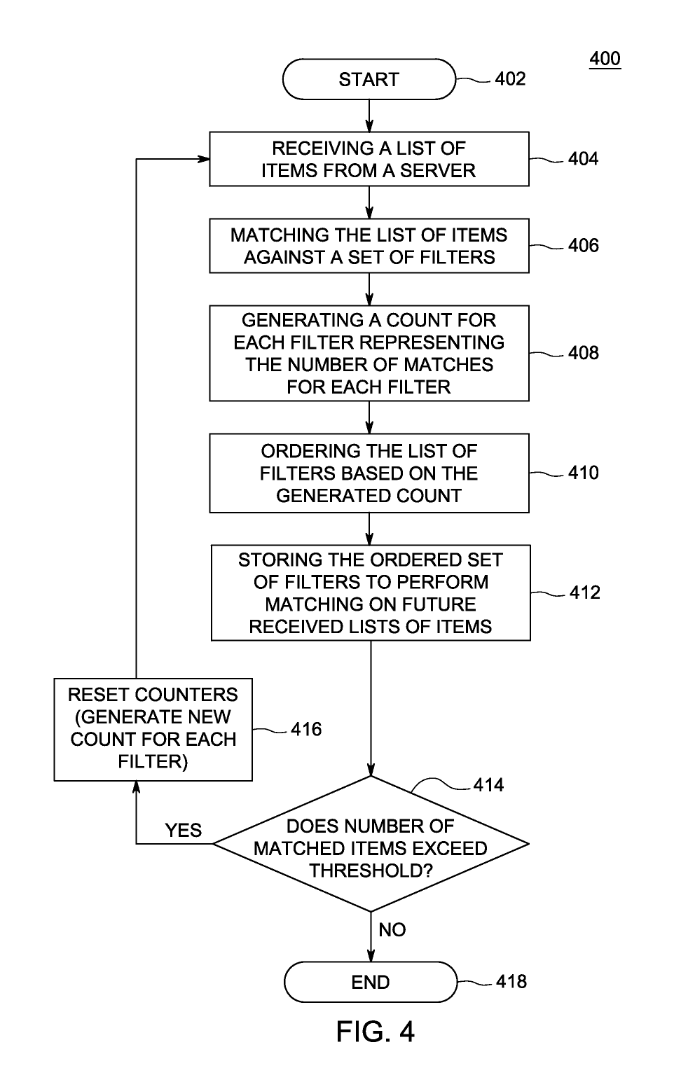

FIG. 4 is a flow diagram for a method 400 in accordance with exemplary embodiments of the present invention. The method 400 illustrates an exemplary flow of the ordering module 100, implemented as the ordering module 308 ordering module 308 as executed on the computer system 300 shown in FIG. 3.

The method 400 begins at step 402 and proceeds to step 404. At step 404, the ordering module 308 receives a list of items or events from a server. According to some embodiments the list of items is a list of plain text lines from a log file, each line representing a recorded event, such as a voicemail message being left on the server, or a call being initiated, or an error in storing the voicemail on the server. According to other embodiments, this list of items is any generic list of items to be categorized or filtered into categories.

At step 406, the filtering module 310 matches, or filters, the list of items against a set of filters, i.e., each filter is applied to every item in the list. When a matching filter is found for a particular item, the filter processing module 311 stops applying filters to the item and moves to the next item in the list. The filter processing module 312 also tracks the number of times, or count, a filter matches a list item and associates the filter to the count at step 408.

The sorting module 312 then sorts, or orders, the filters at step 410 based on the generated count. The filters are ordered from those with greatest count to those with the least count. At step 412, the sorting module 312 stores the ordered set of filters to perform matching on future received list of items. At step 414, the ordering module 308 determines whether the number of items matched thus far exceeds a particular threshold.

According to other embodiments, the ordering apparatus 100 may determine whether a predetermined amount of time has been exceeded, a predetermined time of day has been reached, or a predetermined number of filter applications has occurred. If the number of items matched does exceed a threshold value, the method proceeds to step 416, where the previous counters are reset and new counts are generated for each filter, and the method then receives new items from the server at step 404. If the number of items matched does not exceed the threshold (or any other predetermined condition is not met), the method ends at step 418, where the ordered filters are saved. The saved ordered filters will be used the next time the method is applied to a list of items.

While the foregoing is directed to embodiments of the present invention, other and further embodiments of the invention may be devised without departing from the basic scope thereof, and the scope thereof is determined by the claims that follow.

1. A method for optimizing list filtering comprising:
receiving a list of items from one or more servers;
matching the list of items against a set of filters;
ordering the set of filters based on the frequency of matches for the set of filters for each filter in the set of filters; and
applying the ordered set of filters for matching on a next received list of items.

2. The method of claim 1, further comprising:
reordering each filter in the set of filters after a predetermined number of items have been received and matched.

3. The method of claim 1, further comprising:
reordering each filter in the set of filters at scheduled times of day.

4. The method of claim 1 further comprising:
receiving one or more entities which match frequently occurring items to be ignored; and
adding an ignore filter to the set of filters for matching the frequently occurring items to reduce processing time by ordering the ignore filter before other filters in the set of filters.

5. The method of claim 1 further comprising:
prior to matching the list of items against a set of filters, removing all lines matching one or more entities which match frequently occurring items to be ignored.

6. The method of claim 1 further comprising:
generating one or more new filters based on entities which match frequency occurring items to be ignored; and
adding the one or more new filters to the set of filters.

7. The method of claim 1 wherein each item in the list of items is a line from a textual log file and each line represents an event in a VoIP network.

8. The method of claim 6 wherein each line matches at most one filter.

9. The method of claim 6 further comprising:
receiving the list of items streamed from the tail end of the textual log file.

10. The method of claim 6 further comprising:
receiving the textual log file from the server and then performing the matching on the entirety of the textual log file.

11. An ordering apparatus for optimizing list filtering comprising:
a filtering module for receiving a list of items from one or more server, the filter module further comprising a filter processor for matching the list of items against a set of filters; and
a sorting module, coupled to the filter module, for ordering the set of filters based on the frequency of matches for each filter in the set of filters and applying the ordered set of filters for matching on a next received list of items.

12. The apparatus of claim 11, wherein the filtering module further reorders the set of filters after a predetermined number of items have been received and matched.

13. The apparatus of claim 11, wherein the filtering module further reorders each filter in the set of filters at scheduled times of day.

14. The apparatus of claim 11 wherein the filtering module further:
receives one or more entities which match frequently occurring items to be ignored; and
adds an ignore filter to the set of filters for matching the frequently occurring items to reduce processing time by ordering the ignore filter before other filters in the set of filters.

15. The apparatus of claim 11 wherein the filtering module is configured further for: prior to matching the list of items against a set of filters, removing all lines matching one or more entities which match frequently occurring items to be ignored.

16. The apparatus of claim 11, wherein the filtering module is configured further for generating one or more new filters based on entities which match frequency occurring items to be ignored and adding the one or more new filters to the set of filters.

17. The apparatus of claim 11 wherein each item in the list of items is a line from a textual log file and each line represents an event in a VoIP network.

18. The apparatus of claim 16 wherein each line matches at most one filter.

19. The apparatus of claim 16 wherein the filtering module is further configured for receiving the list of items streamed from the tail end of the textual log file.

20. The apparatus of claim 16 wherein the filtering module is further configured for:
receiving the textual log file from the server and then performing the matching on the entirety of the textual log file.
